(19) United States
(12) Patent Application Publication
(10) Pub. No.: US 2013/0168006 A1
(43) Pub. Date: Jul. 4, 2013

(54) METHOD FOR MANUFACTURING LIQUID CRYSTAL DISPLAY DEVICE

(71) Applicant: Tetsuya Kida, Osaka-shi (JP)

(72) Inventor: Tetsuya Kida, Osaka-shi (JP)

(73) Assignee: SHARP KABUSHIKI KAISHA, Osaka-shi, Osaka (JP)

(21) Appl. No.: 13/823,657

(22) PCT Filed: Oct. 7, 2011
(86) PCT No.: PCT/JP2011/073217

§ 371 Date: Mar. 14, 2013

(30) Foreign Application Priority Data
Oct. 14, 2010 (JP) 2010-231182

(51) Int. Cl. B32B 37/10

(52) U.S. Cl. CPC B32B 37/1009
USPC 156/64; 156/146

(57) ABSTRACT

A method for manufacturing a liquid crystal display device includes the steps of: dropping a liquid crystal onto a substrate containing a smaller amount of adsorbed moisture, of a CF substrate and a TFT substrate; and after the step of dropping the liquid crystal, bonding the CF substrate and the TFT substrate together in a vacuum.

### TECHNICAL FIELD

The present invention relates to a method for manufacturing a liquid crystal display device.

### BACKGROUND ART

In a method for manufacturing a liquid crystal display device, a sealing material is formed on a surface of one of a first substrate and a second substrate, and a liquid crystal is dropped onto a region surrounded by the sealing material, and thereafter, the first substrate and the second substrate are bonded together in the vacuum atmosphere, thereby sealing the liquid crystal. Such a method for dropping the liquid crystal, and then, bonding the substrates together is called “ODF (One Drop Fill)”.

The prior art document that discloses the method for manufacturing the liquid crystal display device using the ODF includes Japanese Patent Laying-Open No. 2009-288364 (PTL 1). A method for manufacturing a liquid crystal display device as described in PTL 1 includes the steps of: applying a main seal onto one of an opposing substrate and a TFT (Thin Film Transistor) substrate; performing pressure reducing treatment on at least one of the opposing substrate and the TFT substrate onto which the main seal has been applied; and bonding the opposing substrate and the TFT substrate together, thereby forming the bonded substrates.

### CITATION LIST

### Patent Literature

PTL 1: Japanese Patent Laying-Open No. 2009-288364

### SUMMARY OF INVENTION

### Technical Problem

The first substrate and the second substrate, which seal the liquid crystal such that the liquid crystal is sandwiched therebetween, are different from each other in terms of an amount of adsorbed moisture due to their configurations. If the liquid crystal is dropped onto the first substrate, and thereafter, the first substrate and the second substrate are bonded together in the vacuum atmosphere when an amount of moisture adsorbed by the first substrate is larger than an amount of moisture adsorbed by the second substrate, the moisture adsorbed by the first substrate hardly evaporates because the moisture is covered with the liquid crystal, and thus, the moisture remains in the sealed liquid crystal. In this case, distribution of the liquid crystal in a liquid crystal panel becomes non-uniform, which leads to display unevenness on a display screen of the liquid crystal display device.

The present invention has been made in view of the aforementioned problem, and an object thereof is to provide a method for manufacturing an image display device, by which the display quality of the liquid crystal display device can be enhanced.

### Solution to Problem

A method for manufacturing a liquid crystal display device according to the present invention is a method for manufacturing a liquid crystal display device, in which a liquid crystal is dropped onto a first substrate or a second substrate, and the first substrate and the second substrate are bonded together in a vacuum such that a surface of the first substrate or the second substrate onto which the liquid crystal has been dropped faces the second substrate or the first substrate onto which the liquid crystal is not dropped, and then, the bonded substrates are returned to an atmospheric pressure, thereby injecting the liquid crystal. The method for manufacturing a liquid crystal display device includes the steps of: dropping the liquid crystal onto a substrate containing a smaller amount of adsorbed moisture, of the first substrate and the second substrate; and after the step of dropping the liquid crystal, bonding the first substrate and the second substrate together in the vacuum.

According to one aspect of the present invention, the liquid crystal display device is manufactured sequentially by repeating the above-described method for manufacturing a liquid crystal display device, wherein a step of measuring an amount of moisture adsorbed by each of the first substrate and the second substrate is first performed in order to determine the substrate containing a smaller amount of adsorbed moisture, of the first substrate and the second substrate. Thereafter, without repeating the step of measuring, the step of dropping the liquid crystal is performed based on the determination.

Preferably, the method for manufacturing a liquid crystal display device further includes the step of: performing pressure reducing treatment on a substrate containing a larger amount of adsorbed moisture, of the first substrate and the second substrate. Or the method for manufacturing a liquid crystal display device further includes the step of: performing heating treatment on a substrate containing a larger amount of adsorbed moisture, of the first substrate and the second substrate. Or the method for manufacturing a liquid crystal display device further includes the step of: performing heating treatment while performing pressure reducing treatment on a substrate containing a larger amount of adsorbed moisture, of the first substrate and the second substrate.

According to one aspect of the present invention, in the heating treatment, the substrate containing a larger amount of adsorbed moisture is heated at a temperature of 40° C. or higher and 300° C. or lower.

Preferably, in the pressure reducing treatment, a pressure of the substrate containing a larger amount of adsorbed moisture is reduced to 100 Pa or smaller.

According to one aspect of the present invention, the method for manufacturing a liquid crystal display device includes the step of: forming different resin films on the first substrate and the second substrate, respectively. A difference in an amount of adsorbed moisture between the first substrate and the second substrate is determined by a difference in an amount of adsorbed moisture between the different resin films.

According to one aspect of the present invention, in the heating treatment, the substrate containing a larger amount of adsorbed moisture is heated at a temperature of 40° C. or higher and 130° C. or lower.

### Advantageous Effects of Invention

According to the present invention, the display quality of the liquid crystal display device can be enhanced.

### BRIEF DESCRIPTION OF DRAWINGS

FIG. 1 is a diagram schematically showing a part of a process for fabricating a liquid crystal panel in a method for manufacturing a liquid crystal display device according to a first embodiment of the present invention.

FIG. 2 is a perspective view showing a state in which a sealing material has been formed on a substrate containing a smaller amount of adsorbed moisture.

FIG. 3 is a perspective view showing a state in which a liquid crystal has been dropped onto the substrate containing a smaller amount of adsorbed moisture.

FIG. 4 is a cross-sectional view showing a state in which two substrates have been bonded together to seal the liquid crystal.

FIG. 5 is a diagram schematically showing a part of a process for fabricating a liquid crystal panel in a method for manufacturing a liquid crystal display device according to a second embodiment of the present invention.

FIG. 6 is a diagram schematically showing a part of a process for fabricating a liquid crystal panel in a method for manufacturing a liquid crystal display device according to a third embodiment of the present invention.

### DESCRIPTION OF EMBODIMENTS

A method for manufacturing a liquid crystal display device according to a first embodiment of the present invention will be described hereinafter with reference to the drawings. In the following description of embodiments, the same reference characters are given to the same or corresponding portions in the drawings and description thereof will not be repeated.

### First Embodiment

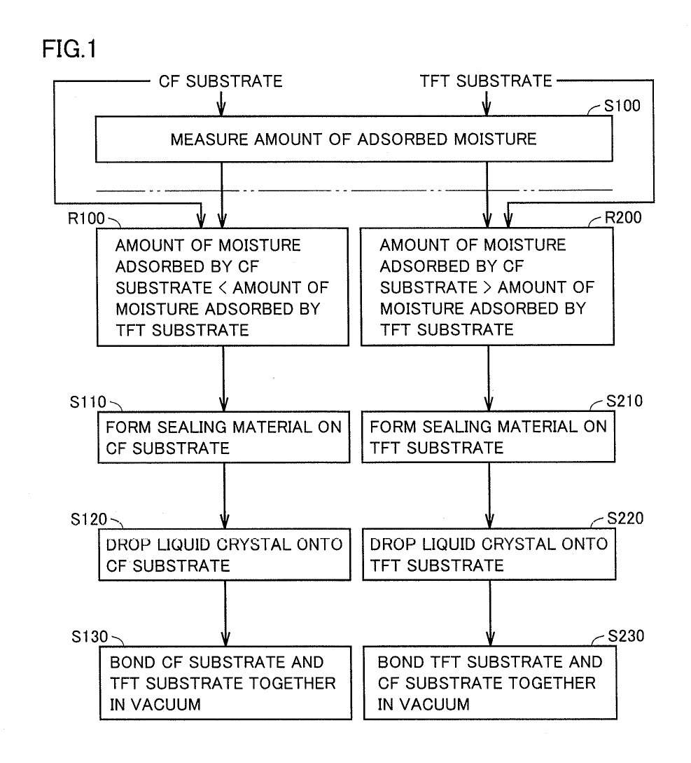

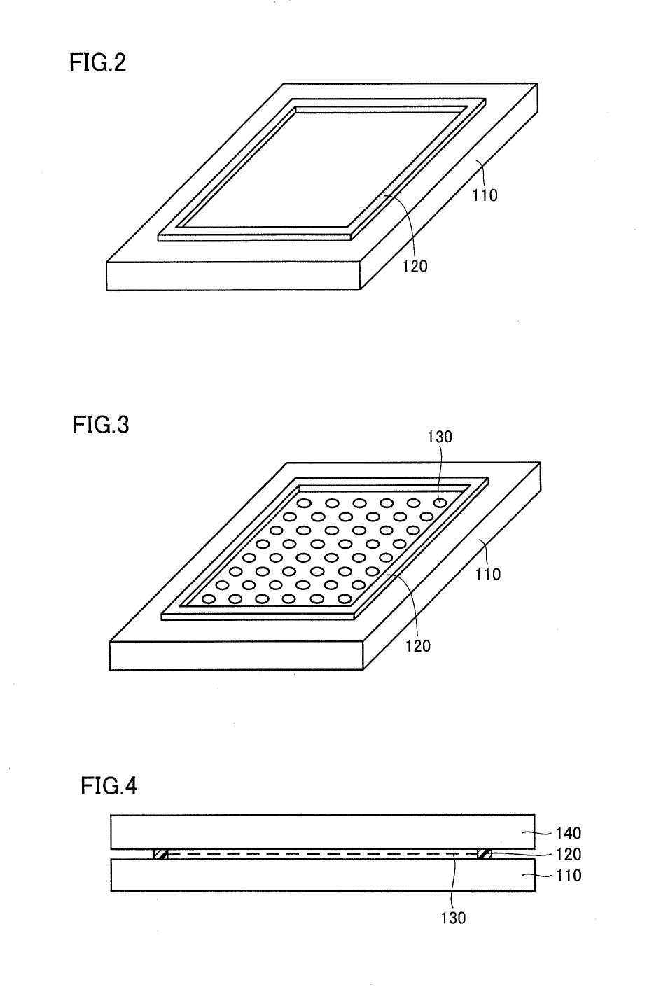

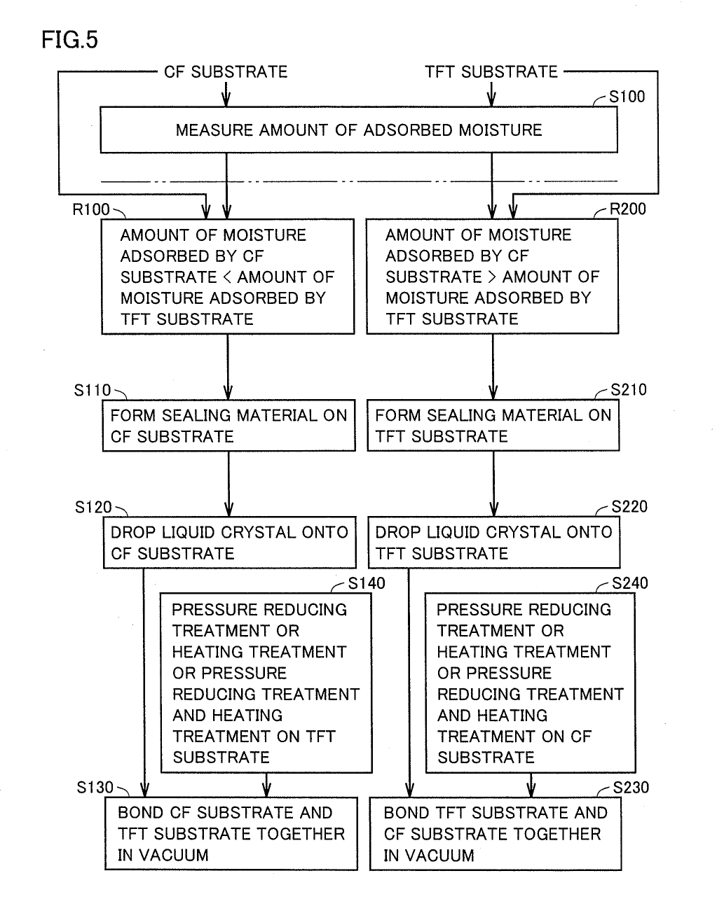

FIG. 1 is a diagram schematically showing a part of a process for fabricating a liquid crystal panel in the method for manufacturing the liquid crystal display device according to the first embodiment of the present invention. FIG. 2 is a perspective view showing a state in which a sealing material has been formed on a substrate containing a smaller amount of adsorbed moisture. FIG. 3 is a perspective view showing a state in which a liquid crystal has been dropped onto the substrate containing a smaller amount of adsorbed moisture. FIG. 4 is a cross-sectional view showing a state in which two substrates have been bonded together to seal the liquid crystal.

As shown in FIG. 1, in the method for manufacturing the liquid crystal display device according to the first embodiment of the present invention, an amount of moisture adsorbed by each of a CF (color filter) substrate serving as a first substrate and a TFT substrate serving as a second substrate is first measured (S100). In the present embodiment, the CF substrate is used as the first substrate and the TFT substrate is used as the second substrate. However, in the case of a liquid crystal display device of color filter on array, for example, a glass substrate may be used as the first substrate and a color filter on array substrate may be used as the second substrate.

A method for measuring the amount of moisture adsorbed by each substrate is as follows. A chamber is sealed off for evacuation, with the substrates placed within the chamber. By measuring a change in pressure within the chamber over time during this evacuation and comparing this change with a change in pressure over time when the substrates are not placed within the chamber, the amount of moisture adsorbed by each substrate can be estimated.

Description will be given first to the method for manufacturing the liquid crystal display device when the amount of moisture adsorbed by the TFT substrate is larger than the amount of moisture adsorbed by the CF substrate (R100) as a result of the measurement of the amount of adsorbed moisture.

In this case, as shown in FIGS. 1 and 2, a sealing material 120 for sealing a liquid crystal is formed on the CF substrate, which is a substrate 110 containing a smaller amount of adsorbed moisture (S110). Sealing material 120 is formed to have a rectangular shape, for example. A sealing material used in conventional liquid crystal display devices can be used as sealing material 120.

Next, as shown in FIG. 3, a liquid crystal 130 is dropped onto substrate 110 having sealing material 120 formed thereon (S120). Liquid crystal 130 is dropped in the shape of a lattice onto a region surrounded by sealing material 120. Liquid crystal 130 can be dropped by using a dispenser and the like.

As shown in FIG. 4, after the step of dropping liquid crystal 130, the CF substrate, which is substrate 110 containing a smaller amount of adsorbed moisture, and the TFT substrate, which is a substrate 140 containing a larger amount of adsorbed moisture, are bonded together in a vacuum (S130). Specifically, the CF substrate and the TFT substrate are bonded together in the vacuum such that the surface of the CF substrate onto which liquid crystal 130 has been dropped faces the TFT substrate, and then, the bonded substrates are returned to an atmospheric pressure, thereby injecting liquid crystal 130.

By sealing liquid crystal 130 by the CF substrate, the TFT substrate and sealing material 120 as described above, most of the moisture adsorbed by the TFT substrate evaporates in the vacuum, and thus, remaining of the moisture adsorbed by the TFT substrate in sealed liquid crystal 130 can be suppressed. As a result, distribution of the liquid crystal in the liquid crystal panel can be made uniform and the display quality of the liquid crystal display device can be enhanced.

Next, description will be given to the method for manufacturing the liquid crystal display device when the amount of moisture adsorbed by the CF substrate is larger than the amount of moisture adsorbed by the TFT substrate (R200) as a result of the measurement of the amount of adsorbed moisture.

In this case, as shown in FIGS. 1 and 2, sealing material 120 for sealing the liquid crystal is formed on the TFT substrate, which is substrate 110 containing a smaller amount of adsorbed moisture (S210). Sealing material 120 is formed to have a rectangular shape, for example. A sealing material used in conventional liquid crystal display devices can be used as sealing material 120.

Next, as shown in FIG. 3, liquid crystal 130 is dropped onto substrate 110 having sealing material 120 formed thereon (S220). Liquid crystal 130 is dropped in the shape of a lattice onto a region surrounded by sealing material 120. Liquid crystal 130 can be dropped by using a dispenser and the like.

As shown in FIG. 4, after the step of dropping liquid crystal 130, the TFT substrate, which is substrate 110 containing a smaller amount of adsorbed moisture, and the CF substrate, which is substrate 140 containing a larger amount of adsorbed moisture, are bonded together in a vacuum (S230). Specifically, the CF substrate and the TFT substrate are bonded together in the vacuum such that the surface of the TFT substrate onto which liquid crystal 130 has been dropped faces the CF substrate, and then, the bonded substrates are returned to an atmospheric pressure, thereby injecting liquid crystal 130.

By sealing liquid crystal 130 by the CF substrate, the TFT substrate and sealing material 120 as described above, most of the moisture adsorbed by the CF substrate evaporates in the vacuum, and thus, remaining of the moisture adsorbed by the CF substrate in sealed liquid crystal 130 can be suppressed. As a result, distribution of the liquid crystal in the liquid crystal panel can be made uniform and the display quality of the liquid crystal display device can be enhanced.

Whether the amount of moisture adsorbed by the CF substrate is larger or the amount of moisture adsorbed by the TFT substrate is larger does not vary unless their configurations vary. Therefore, when the liquid crystal display device is mass-produced, the measurement of the amount of adsorbed moisture (S100) is performed first and is never performed after that.

In other words, after the measurement of the amount of adsorbed moisture (S100) is performed once and it is determined whether the amount of moisture adsorbed by the CF substrate is larger or the amount of moisture adsorbed by the TFT substrate is larger, the step of forming sealing material 120 on substrate 110 containing a smaller amount of adsorbed moisture and the subsequent steps are performed based on this determination, without repeating the measurement of the amount of adsorbed moisture (S100).

A method for manufacturing a liquid crystal display device according to a second embodiment of the present invention will be described hereinafter with reference to the drawing.

### Second Embodiment

The method for manufacturing the liquid crystal display device according to the present embodiment is different from the method for manufacturing the liquid crystal display device according to the first embodiment, only in that additional treatment is performed on substrate 140 containing a larger amount of adsorbed moisture, and thus, description of the other steps will not be repeated.

FIG. 5 is a diagram schematically showing a part of a process for fabricating a liquid crystal panel in the method for manufacturing the liquid crystal display device according to the second embodiment of the present invention. Description will be given first to the method for manufacturing the liquid crystal display device when the amount of moisture adsorbed by the TFT substrate is larger than the amount of moisture adsorbed by the CF substrate (R100) as a result of the measurement of the amount of adsorbed moisture.

As shown in FIG. 5, in the method for manufacturing the liquid crystal display device according to the second embodiment of the present invention, prior to the step of bonding the CF substrate and the TFT substrate together in the vacuum (S130), heating treatment is performed while pressure reducing treatment is performed on the TFT substrate, which is substrate 140 containing a larger amount of adsorbed moisture (S140).

In the pressure reducing treatment, the pressure is reduced to 100 Pa or smaller. By doing so, the moisture adsorbed by the TFT substrate can be effectively evaporated.

In the heating treatment, substrate 140 is heated at a temperature of 40° C. or higher and 300° C. or lower. This is because the moisture adsorbed by the TFT substrate cannot be effectively evaporated when the heating temperature is lower than 40° C., and the properties of the TFT substrate change and the performance of the liquid crystal display device deteriorates when the heating temperature is higher than 300° C.

By performing the heating treatment while performing the pressure reducing treatment on the TFT substrate as described above, the moisture adsorbed by the TFT substrate can be evaporated. The TFT substrate from which the moisture has evaporated adsorbs a small amount of moisture during bonding the TFT substrate and the CF substrate together in the vacuum in the next step. However, as compared with the case where the pressure reducing treatment and the heating treatment are not performed, remaining of the moisture adsorbed by the TFT substrate in liquid crystal 130 sealed by bonding the CF substrate and the TFT substrate together in the vacuum can be suppressed. As a result, distribution of the liquid crystal in the liquid crystal panel can be made uniform and the display quality of the liquid crystal display device can be enhanced.

As a modification of the present embodiment, instead of performing the heating treatment while performing the pressure reducing treatment on the TFT substrate, only the pressure reducing treatment or only the heating treatment may be performed. In this case as well, the moisture adsorbed by the TFT substrate can be evaporated. As a result, remaining of the moisture adsorbed by the TFT substrate in liquid crystal 130 sealed by bonding the CF substrate and the TFT substrate together in the vacuum can be suppressed.

Next, description will be given to the method for manufacturing the liquid crystal display device when the amount of moisture adsorbed by the CF substrate is larger than the amount of moisture adsorbed by the TFT substrate (R200) as a result of the measurement of the amount of adsorbed moisture.

In this case, as shown in FIG. 5, prior to the step of bonding the CF substrate and the TFT substrate together in the vacuum (S230), the heating treatment is performed while the pressure reducing treatment is performed on the CF substrate, which is substrate 140 containing a larger amount of adsorbed moisture (S240).

In the pressure reducing treatment, the pressure is reduced to 100 Pa or smaller. By doing so, the moisture adsorbed by the TFT substrate can be effectively evaporated.

In the heating treatment, substrate 140 is heated at a temperature of 40° C. or higher and 130° C. or lower. This is because the moisture adsorbed by the CF substrate cannot be effectively evaporated when the heating temperature is lower than 40° C., and a resin film of the CF substrate that will form a colored layer is decomposed and the performance of the liquid crystal display device deteriorates when the heating temperature is higher than 130° C.

By performing the heating treatment while performing the pressure reducing treatment on the CF substrate as described above, the moisture adsorbed by the CF substrate can be evaporated. The CF substrate from which the moisture has evaporated adsorbs a small amount of moisture during bonding the TFT substrate and the CF substrate together in the vacuum in the next step. However, as compared with the case where the pressure reducing treatment and the heating treatment are not performed, remaining of the moisture adsorbed by the CF substrate in liquid crystal 130 sealed by bonding the CF substrate and the TFT substrate together in the vacuum can be suppressed. As a result, distribution of the liquid crystal in the liquid crystal panel can be made uniform and the display quality of the liquid crystal display device can be enhanced.

As a modification of the present embodiment, instead of performing the heating treatment while performing the pressure reducing treatment on the CF substrate, only the pressure reducing treatment or only the heating treatment may be performed. In this case as well, the moisture adsorbed by the CF substrate can be evaporated. As a result, remaining of the moisture adsorbed by the CF substrate in liquid crystal 130 sealed by bonding the CF substrate and the TFT substrate together in the vacuum can be suppressed.

A method for manufacturing a liquid crystal display device according to a third embodiment of the present invention will be described hereinafter with reference to the drawing.

### Third Embodiment

The method for manufacturing the liquid crystal display device according to the present embodiment is different from the method for manufacturing the liquid crystal display device according to the second embodiment, only in that different resin films are formed on the first substrate and the second substrate, respectively, and thus, description of the other steps will not be repeated.

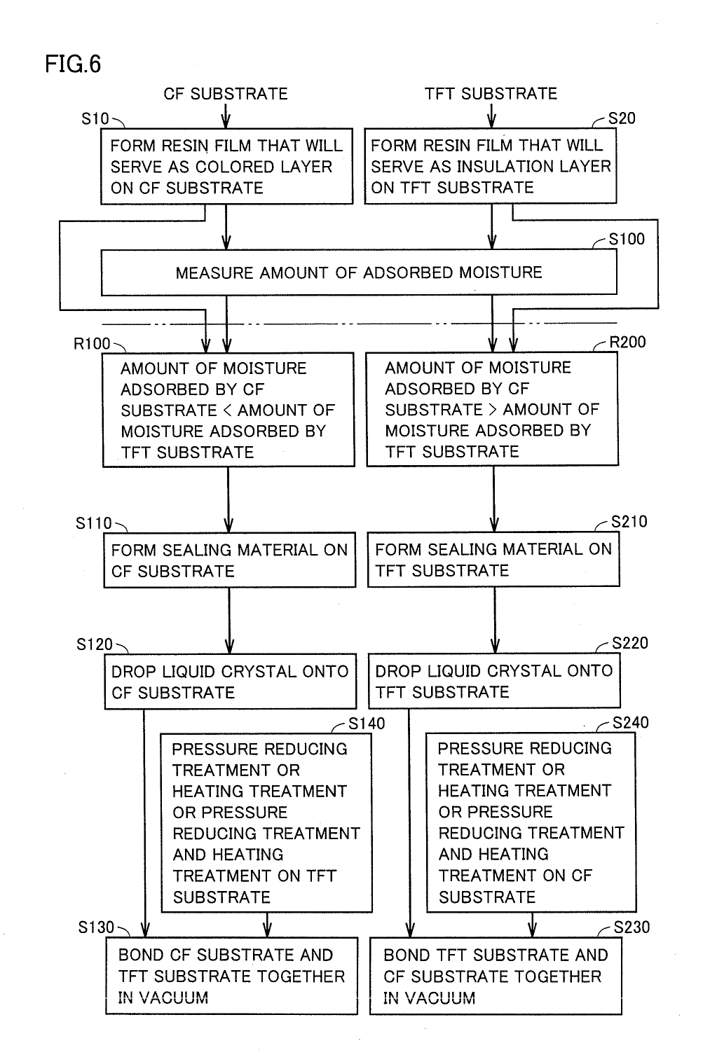

FIG. 6 is a diagram schematically showing a part of a process for fabricating a liquid crystal panel in the method for manufacturing the liquid crystal display device according to the third embodiment of the present invention.

As shown in FIG. 6, the method for manufacturing the liquid crystal display device according to the present embodiment includes a step of forming a resin film that will serve as a colored layer on the CF substrate serving as the first substrate (S10).

As shown in FIG. 6, in the method for manufacturing the liquid crystal display device according to the third embodiment of the present invention, a resin film that is different from the resin film formed on the CF substrate is formed on the TFT substrate serving as the second substrate. Specifically, the method for manufacturing the liquid crystal display device includes a step of forming a resin film that will serve as an insulation layer on the TFT substrate (S20).

The resin film formed on the TFT substrate is made of, for example, a novolac-based resin. This resin film has, for example, a function of preventing an unintended orientation of the liquid crystal due to a wiring voltage in the TFT substrate or a function of preventing occurrence of short circuit due to foreign objects such as metal between the TFT substrate and the CF substrate.

The percentage of an amount of moisture adsorbed by the resin film of each substrate is high in the amount of moisture adsorbed by each of the CF substrate and the TFT substrate. Therefore, a difference in the amount of adsorbed moisture between the CF substrate and the TFT substrate is determined by a difference in the amount of adsorbed moisture between the resin film formed on the CF substrate and the resin film formed on the TFT substrate.

In other words, when the amount of moisture adsorbed by the resin film formed on the TFT substrate is larger than the amount of moisture adsorbed by the resin film formed on the CF substrate, the amount of moisture adsorbed by the TFT substrate is larger than the amount of moisture adsorbed by the CF substrate (R100) as a result of the measurement of the amount of adsorbed moisture (S100).

In this case, the sealing material is formed on the CF substrate (S110), and then, the liquid crystal is dropped onto the CF substrate (S120). In addition, the heating treatment is performed while the pressure reducing treatment is performed on the TFT substrate, which is substrate 140 containing a larger amount of adsorbed moisture (S140). In the method for manufacturing the liquid crystal display device according to the modification of the present embodiment, the pressure reducing treatment or the heating treatment is performed on the TFT substrate.

In the pressure reducing treatment, the pressure is reduced to 100 Pa or smaller. By doing so, the moisture adsorbed by the TFT substrate can be effectively evaporated.

In the heating treatment, TFT substrate 140 is heated at a temperature of 40° C. or higher and 130° C. or lower. This is because the moisture adsorbed by the TFT substrate cannot be effectively evaporated when the heating temperature is lower than 40° C., and the resin film of the TFT substrate that will form the insulation layer is decomposed and the performance of the liquid crystal display device deteriorates when the heating temperature is higher than 130° C.

Thereafter, the CF substrate and the TFT substrate are bonded together in a vacuum (S130). Specifically, the CF substrate and the TFT substrate are bonded together in the vacuum such that the surface of the CF substrate onto which liquid crystal 130 has been dropped faces the TFT substrate, and then, the bonded substrates are returned to an atmospheric pressure, thereby injecting liquid crystal 130.

By manufacturing the liquid crystal display device as described above, remaining of the moisture adsorbed by the CF substrate and the TFT substrate in sealed liquid crystal 130 can be suppressed. As a result, distribution of the liquid crystal in the liquid crystal panel can be made uniform and the display quality of the liquid crystal display device can be enhanced.

On the other hand, when the amount of moisture adsorbed by the resin film formed on the CF substrate is larger than the amount of moisture adsorbed by the resin film formed on the TFT substrate, the amount of moisture adsorbed by the CF substrate is larger than the amount of moisture adsorbed by the TFT substrate (R200) as a result of the measurement of the amount of adsorbed moisture (S 100).

In this case, the sealing material is formed on the TFT substrate (S210), and then, the liquid crystal is dropped onto the TFT substrate (S220). In addition, the heating treatment is performed while the pressure reducing treatment is performed on the CF substrate, which is substrate 140 containing a larger amount of adsorbed moisture (S240). In the method for manufacturing the liquid crystal display device according to the modification of the present embodiment, the pressure reducing treatment or the heating treatment is performed on the CF substrate.

In the pressure reducing treatment, the pressure is reduced to 100 Pa or smaller. By doing so, the moisture adsorbed by the CF substrate can be effectively evaporated.

In the heating treatment, CF substrate 140 is heated at a temperature of 40° C. or higher and 130° C. or lower. This is because the moisture adsorbed by the CF substrate cannot be effectively evaporated when the heating temperature is lower than 40° C., and the resin film of the CF substrate that will form the colored layer is decomposed and the performance of the liquid crystal display device deteriorates when the heating temperature is higher than 130° C.

Thereafter, the CF substrate and the TFT substrate are bonded together in a vacuum (S230). Specifically, the CF substrate and the TFT substrate are bonded together in the vacuum such that the surface of the TFT substrate onto which liquid crystal 130 has been dropped faces the CF substrate, and then, the bonded substrates are returned to an atmospheric pressure, thereby injecting liquid crystal 130.

By manufacturing the liquid crystal display device as described above, remaining of the moisture adsorbed by the CF substrate and the TFT substrate in sealed liquid crystal 130 can be suppressed. As a result, distribution of the liquid crystal in the liquid crystal panel can be made uniform and the display quality of the liquid crystal display device can be enhanced.

It should be construed that the embodiments disclosed herein are by way of illustration in all respects and not intended to be limiting. It is intended that the technical scope of the present invention is defined by claims, not by the embodiments described above, and includes all modifications and variations equivalent in meaning and scope to the claims.

### REFERENCE SIGNS LIST

110 substrate containing a smaller amount of adsorbed moisture; 120 sealing material; 130 liquid crystal; 140 substrate containing a larger amount of adsorbed moisture

1. A method for manufacturing a liquid crystal display device, in which a liquid crystal is dropped onto a first substrate or a second substrate, and said first substrate and said second substrate are bonded together in a vacuum such that a surface of said first substrate or said second substrate onto which the liquid crystal has been dropped faces said second substrate or said first substrate onto which the liquid crystal is not dropped, and then, the bonded substrates are returned to an atmospheric pressure, thereby injecting the liquid crystal, the method comprising the steps of:
dropping the liquid crystal onto a substrate containing a smaller amount of adsorbed moisture, of said first substrate and said second substrate; and
after said step of dropping the liquid crystal, bonding said first substrate and said second substrate together in the vacuum.

2. The method for manufacturing a liquid crystal display device according to claim 1, the liquid crystal display device being manufactured sequentially by repeating the method for manufacturing a liquid crystal display device as recited in claim 1, wherein
a step of measuring an amount of moisture adsorbed by each of said first substrate and said second substrate is first performed in order to determine the substrate containing a smaller amount of adsorbed moisture, of said first substrate and said second substrate, and
thereafter, without repeating said step of measuring, said step of dropping the liquid crystal is performed based on said determination.

3. The method for manufacturing a liquid crystal display device according to claim 1, further comprising the step of:
performing pressure reducing treatment on a substrate containing a larger amount of adsorbed moisture, of said first substrate and said second substrate.

4. The method for manufacturing a liquid crystal display device according to claim 1, further comprising the step of:
performing heating treatment on a substrate containing a larger amount of adsorbed moisture, of said first substrate and said second substrate.

5. The method for manufacturing a liquid crystal display device according to claim 1, further comprising the step of:
performing heating treatment while performing pressure reducing treatment on a substrate containing a larger amount of adsorbed moisture, of said first substrate and said second substrate.

6. The method for manufacturing a liquid crystal display device according to claim 4, wherein
in said heating treatment, said substrate containing a larger amount of adsorbed moisture is heated at a temperature of 40° C. or higher and 300° C. or lower.

7. The method for manufacturing a liquid crystal display device according to claim 3, wherein
in said pressure reducing treatment, a pressure of said substrate containing a larger amount of adsorbed moisture is reduced to 100 Pa or smaller.

8. The method for manufacturing a liquid crystal display device according to claim 4, further comprising the step of:
forming different resin films on said first substrate and said second substrate, respectively, wherein
a difference in an amount of adsorbed moisture between said first substrate and said second substrate is determined by a difference in an amount of adsorbed moisture between said different resin films.

9. The method for manufacturing a liquid crystal display device according to claim 8, wherein
in said heating treatment, said substrate containing a larger amount of adsorbed moisture is heated at a temperature of 40° C. or higher and 130° C. or lower.
